(19) United States
(12) Patent Application Publication
(10) Pub. No.: US 2025/0183589 A1
(43) Pub. Date: Jun. 5, 2025

(54) FLOATING CONNECTOR

(71) Applicant: J.S.T. MFG. CO., LTD., Tokyo (JP)

(72) Inventors: Masaki TSUJIMOTO, Yokohama-shi (JP); Hideya OKAZAKI, Yokohama-shi (JP)

(73) Assignee: J.S.T. MFG. CO., LTD., Tokyo (JP)

(21) Appl. No.: 18/962,455

(22) Filed: Nov. 27, 2024

(30) Foreign Application Priority Data
Dec. 4, 2023 (JP) 2023-204746

(51) Int. Cl. H01R 13/631; H01R 13/24; H01R 13/502

(52) U.S. Cl. CPC H01R 13/6315; H01R 13/2428; H01R 13/502

(57) ABSTRACT

A floating connector includes a movable housing accommodated in an accommodation portion of a stationary housing in a loosely fitted state and a terminal integrally formed of a single member. The terminal includes a first fixed portion fixed to a first fixing portion of the stationary housing, a second fixed portion fixed to a second fixing portion of the movable housing, a mating terminal fitting portion, and an elastic portion coupling the first fixed portion and the second fixed portion. The elastic portion is elastically deformable along with movement of the movable housing with respect to three orthogonal directions including a connector fitting direction.

### CROSS REFERENCE TO RELATED APPLICATION

This application corresponds to Japanese Patent Application No. 2023-204746 filed with the Japan Patent Office on Dec. 4, 2023, the entire disclosure of which is incorporated herein by reference.

### BACKGROUND OF THE INVENTION

### Field of the Invention

The present invention relates to a floating connector.

### Description of Related Arts

The battery connector disclosed in Japanese Patent Application Publication No. 2008-97961 includes a connection portion that connects an electric circuit of a laptop computer main body and a battery pack. A pair of shaft portions are inserted through a pair of hole portions of an attachment base for attaching the connection portion to the laptop computer main body and a pair of hole portions of the connection portion. The pair of shaft portions is inserted through a pair of elastic body portions, and the pair of shaft portions support the connection portion via the pair of elastic body portions. The connection portion is freely movable with respect to the laptop computer main body by the elasticity of the pair of elastic body portions. That is, a combination of the pair of shaft portions, the pair of elastic body portions, and the attachment base implements a floating structure in which the connection portion freely moves with respect to the laptop computer main body.

In Japanese Patent Application Publication No. 2008-97961, the number of parts for implementing the floating structure is large, and the number of assembling steps at the time of manufacturing is also large.

### SUMMARY OF THE INVENTION

A preferred embodiment of the present invention provides a floating connector capable of reducing the number of parts and reducing the number of assembling steps at the time of manufacturing.

A preferred embodiment of the present invention provides a floating connector including a stationary housing including a first fixing portion and an accommodation portion, a movable housing including a second fixing portion disposed closer to a connector fitting direction than the first fixing portion and being accommodated in the accommodation portion in a loosely fitted state, and a terminal integrally formed of a single member. The terminal includes a first fixed portion fixed to the first fixing portion, a second fixed portion fixed to the second fixing portion, a mating terminal fitting portion protruding from the second fixed portion in the connector fitting direction and configured to be fitted to a mating terminal, and an elastic portion coupling the first fixed portion and the second fixed portion to each other. The elastic portion is configured to be elastically deformable along with movement of the movable housing with respect to three orthogonal directions including the connector fitting direction, as well as a first orthogonal direction and a second orthogonal direction which are orthogonal to the connector fitting direction.

According to this configuration, the movement of the movable housing with respect to the three orthogonal directions can be elastically absorbed by the elastic portion of the terminal integrally formed of a single member. Therefore, the number of parts can be reduced, and the number of assembling steps at the time of manufacturing can be reduced.

In one preferred embodiment, the elastic portion includes a meandering portion that meanders in the connector fitting direction and an opposite direction to the connector fitting direction and extends in the second orthogonal direction when viewed from the first orthogonal direction. The meandering portion includes a first curved plate portion having a folded-back shape opening in the opposite direction and a second curved plate portion having a folded-back shape opening in the connector fitting direction.

According to this configuration, when the movable housing moves in the first orthogonal direction, in the meandering portion, each of the first curved plate portion and the second curved plate portion that open in opposite directions with respect to the connector fitting direction is elastically and torsionally deformed. The movement of the movable housing in the first orthogonal direction can be satisfactorily absorbed by using the elastic torsional deformation of the first curved plate portion and the second curved plate portion.

In one preferred embodiment, the meandering portion includes a first linear plate portion, a second linear plate portion, and a third linear plate portion and forms a Z-shape when viewed from the first orthogonal direction. According to this configuration, it is possible to satisfactorily absorb the movement of the movable housing in the connector fitting direction and in the opposite direction using the elastic deformation of the meandering portion forming the Z-shape when viewed from the first orthogonal direction.

In one preferred embodiment, the first linear plate portion includes a first end coupled to the first fixed portion and a second end. The second linear plate portion includes a first end coupled to the second fixed portion and a second end. The third linear plate portion includes a first end coupled to the second end of the first linear plate portion via the first curved plate portion and a second end coupled to the second end of the second linear plate portion via the second curved plate portion.

According to this configuration, it is possible to satisfactorily absorb the movement of the movable housing in the connector fitting direction and in the opposite direction using the elastic deformation of the first curved plate portion and the second curved plate portion of the meandering portion.

In one preferred embodiment, the second fixed portion includes a pair of opposing walls facing each other in the first orthogonal direction and a bridging wall extending in the connector fitting direction and the first orthogonal direction and coupling the pair of opposing walls to each other. The first end of the second linear plate portion is directly coupled to the bridging wall. According to this configuration, the structure of the elastic portion can be simplified by directly coupling one end of the second linear plate portion of the meandering portion to the bridging wall of the second fixed portion.

In one preferred embodiment, the second fixed portion includes a pair of opposing walls facing each other in the first orthogonal direction and a bridging wall extending in the connector fitting direction and the first orthogonal direction and coupling the pair of opposing walls to each other. The second linear plate portion includes a pair of bent edge portions that are bent from the first end of the second linear plate portion and face each other in the first orthogonal direction. The elastic portion includes a pair of coupling plate portions that couple the pair of opposing walls of the second fixed portion to the pair of bent edge portions of the second linear plate portion. Each of the pair of coupling plate portions has a plate thickness direction along the first orthogonal direction and is configured to be elastically and torsionally deformable along with movement of the movable housing in the first orthogonal direction.

According to this configuration, by using the elastic torsional deformation of the pair of coupling plate portions in addition to the elastic torsional deformation of the first curved plate portion and the second curved plate portion, the movement of the movable housing in the first orthogonal direction can be more satisfactorily absorbed.

In one preferred embodiment, each of the pair of coupling plate portions includes a fourth linear plate portion extending in the opposite direction from the corresponding edge portion of the first end of the second linear plate portion, a fifth linear plate portion extending in the opposite direction from the corresponding opposing wall of the second fixed portion, and a third curved plate portion having a folded-back shape between an extended end of the fourth linear plate portion and an extended end of the fifth linear plate portion.

According to this configuration, by using the elastic torsional deformation of the third curved plate portion between the fourth linear plate portion and the fifth linear plate portion in addition to the elastic torsional deformation of the first curved plate portion and the second curved plate portion of the meandering portion, the movement of the movable housing in the first orthogonal direction can be satisfactorily absorbed.

In one preferred embodiment, the floating connector further includes a shunt terminal. The terminal includes a power supply terminal including a first lead extending from the first fixed portion and configured to be connectable to a substrate. The shunt terminal includes a contact portion in contact with the power supply terminal, a second lead connectable to the substrate, and a heat dissipation plate extending between the contact portion and the second lead and is configured to shunt a current flowing through the power supply terminal.

According to this configuration, a current flowing through the power supply terminal can be shunted, and the temperature rise of the power supply terminal and the shunt terminal can be suppressed.

In a preferred embodiment of the present invention, the mating terminal connection portion is configured to be connectable to a mating terminal of a mating connector provided in a battery or a battery pack. According to this configuration, it is possible to obtain a floating connector functioning as a battery connector capable of reducing the number of parts and reducing the number of assembling steps at the time of manufacturing.

### BRIEF DESCRIPTION OF THE DRAWINGS

FIGS. 1A and 1B are perspective views of a floating connector according to a preferred embodiment of the present invention from different angles to each other.

FIGS. 2A and 2B are plan views of the floating connector, illustrating a state before fitting to a mating connector and a state after fitting to the mating connector.

FIG. 3 is an exploded perspective view of the floating connector.

FIG. 4A is a side view of the floating connector.

FIG. 4B is a cross-sectional view of the floating connector and corresponds to a cross-sectional view taken along line IV-IV in FIG. 2A.

FIGS. 5A and 5B are perspective views of a stationary housing from different angles to each other.

FIG. 6 is a rear view of the stationary housing.

FIGS. 7A and 7B are perspective views of a movable housing from different angles to each other.

FIG. 8A is a plan view of a terminal, FIG. 8B is a side view of the terminal, FIG. 8C is a bottom view of the terminal, and FIG. 8D is a rear view of the terminal.

FIGS. 9A and 9B are perspective views of the terminal from different angles to each other.

FIGS. 10A and 10B are perspective views of a pair of power supply terminals to which shunt terminals are attached, from different angles to each other.

FIG. 11A is a plan view of the terminal when the terminal is at the home position, and FIG. 11B is a plan view of the terminal when the displacement in the first orthogonal direction is absorbed.

FIG. 12A is a side view of the terminal when the terminal is at the home position, FIG. 12B is a side view of the terminal when pulled in the connector fitting direction, and FIG. 12C is a side view of the terminal when pushed in the opposite direction to the connector fitting direction.

FIG. 13A is a side view of the terminal when the terminal is at the home position and FIG. 13B is a side view of the terminal when the displacement in the second orthogonal direction is absorbed.

FIGS. 14A and 14B are perspective views of a terminal according to a modification from different angles to each other.

FIG. 15A is a plan view of the terminal according to the modification when the terminal is at the home position, and FIG. 15B is a plan view of the terminal according to the modification when the displacement in the first orthogonal direction is absorbed.

FIG. 16A is a side view of the terminal according to the modification when the terminal is at the home position, FIG. 16B is a side view of the terminal according to the modification when pulled in the connector fitting direction, and FIG. 16C is a side view of the terminal according to the modification when pushed in the opposite direction to the connector fitting direction.

FIG. 17A is a side view of the terminal according to the modification when the terminal is at the home position, and FIG. 17B is a side view of the terminal according to the modification when the displacement in the second orthogonal direction is absorbed.

### DETAILED DESCRIPTION OF THE PREFERRED EMBODIMENT

Hereinafter, a preferred embodiment embodying the present invention will be described with reference to the accompanying drawings.

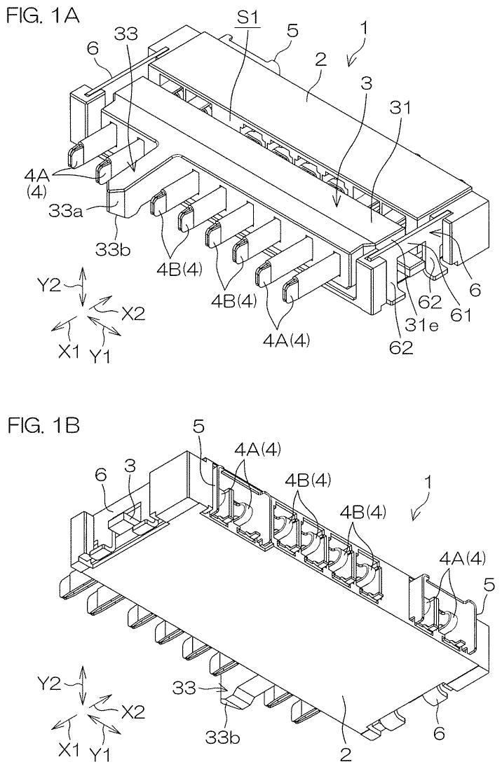

FIGS. 1A and 1B are perspective views of a floating connector according to a preferred embodiment of the present invention from different angles to each other.

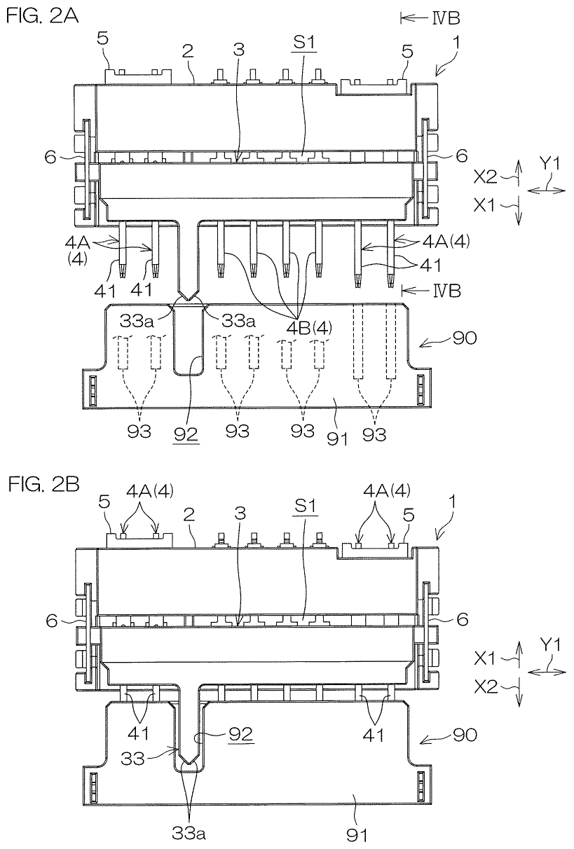

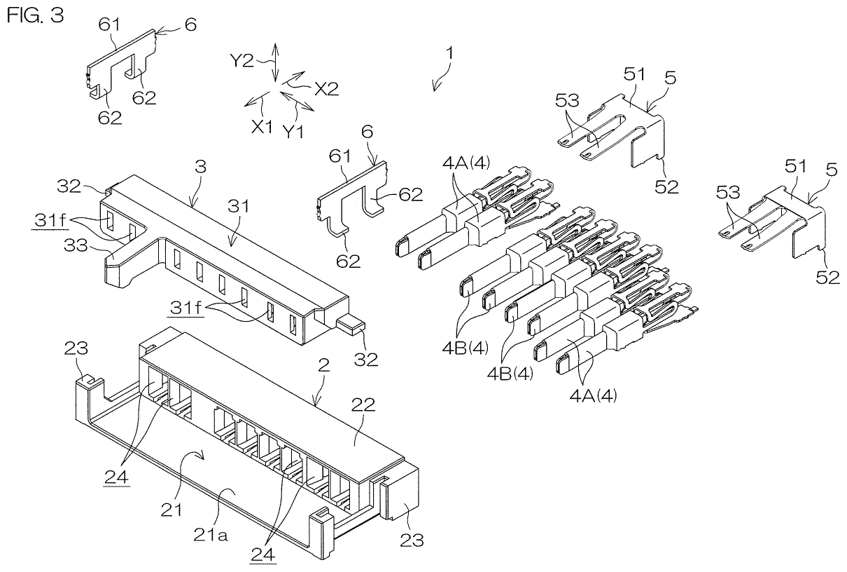

FIGS. 2A and 2B are plan views of the floating connector, illustrating a state before fitting to a mating connector and a state after fitting to the mating connector. FIG. 3 is an exploded perspective view of the floating connector.

As illustrated in FIGS. 1A, 1B, and 3, a floating connector 1 includes an insulating stationary housing 2, an insulating movable housing 3, a plurality of conductive terminals 4, a pair of conductive shunt terminals 5, and a pair of metal reinforcing tabs 6. As illustrated in FIGS. 2A and 2B, the floating connector 1 is fitted to a mating connector 90 in a connector fitting direction X1. For example, the mating connector 90 may be provided in a battery or a battery pack for a portable information terminal (for example, a laptop computer), and the floating connector 1 may be provided in a portable information terminal main body (for example, a laptop computer main body). In that case, the floating connector 1 functions as a battery connector.

Hereinafter, the connector fitting direction X1 and a first orthogonal direction Y1 and a second orthogonal direction Y2 orthogonal to the connector fitting direction X1 are referred to as three orthogonal directions.

Referring to FIG. 1A, the connector fitting direction X1 corresponds to the front, and an opposite direction X2 to the connector fitting direction X1 corresponds to the rear. Also, the first orthogonal direction Y1 corresponds to the left-right direction, and the second orthogonal direction Y2 corresponds to the up-down direction.

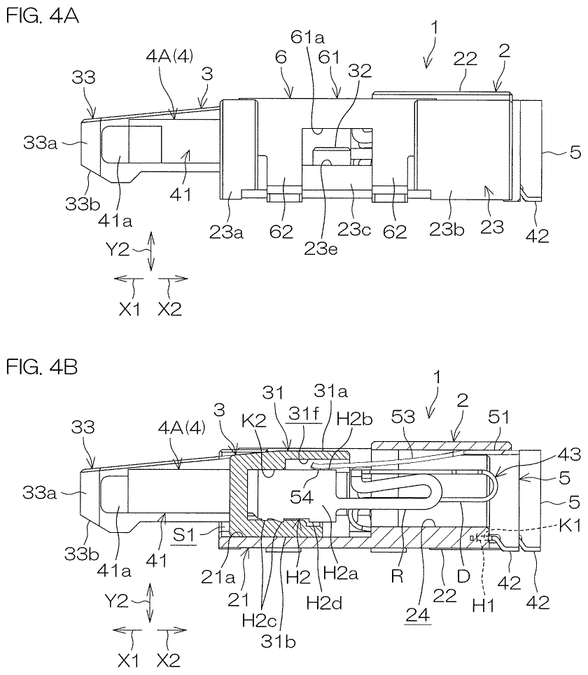

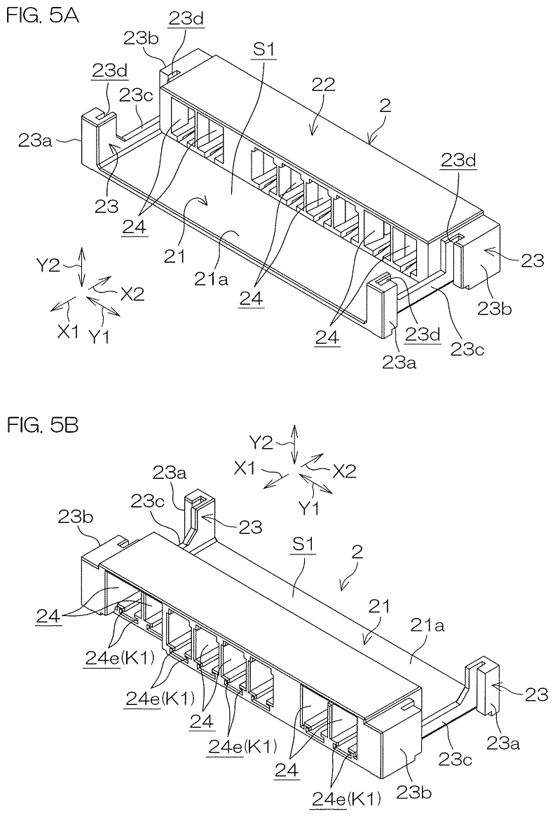

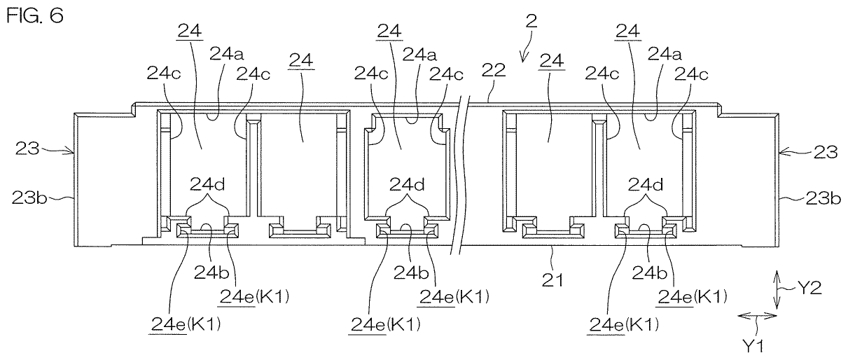

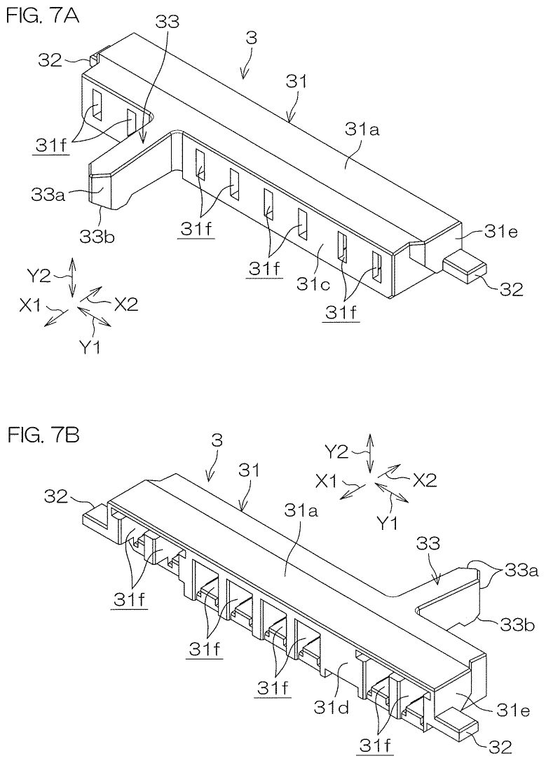

FIG. 4A is a side view of the floating connector 1. FIG. 4B is a cross-sectional view of the floating connector 1 and corresponds to a cross-sectional view taken along line IV-IV in FIG. 2A. FIGS. 5A and 5B are perspective views of the stationary housing 2 from different angles to each other. FIG. 6 is a rear view of the stationary housing 2. FIGS. 7A and 7B are perspective views of the movable housing 3 from different angles to each other.

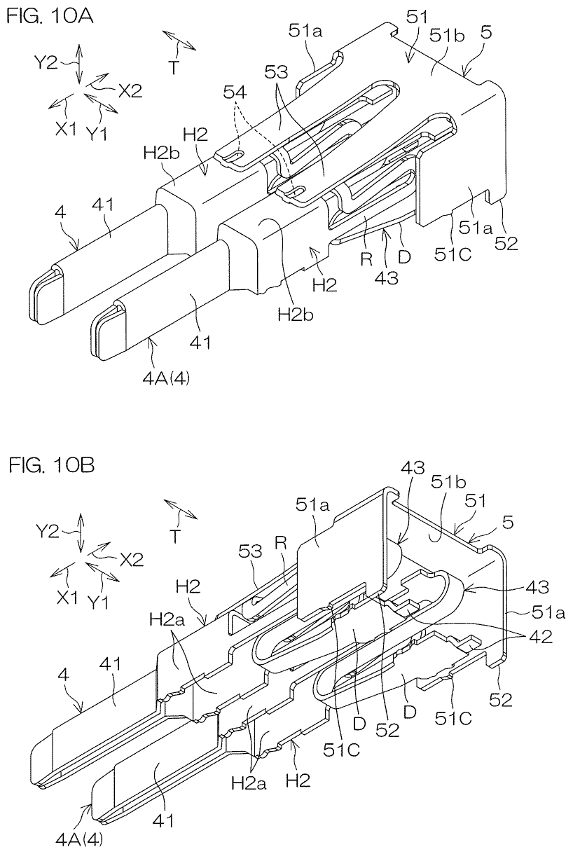

As illustrated in FIGS. 1A and 5A, the stationary housing 2 includes an accommodation portion S1 that accommodates the movable housing 3 in a loosely fitted state and a first fixing portion K1 (see FIG. 6). The movable housing 3 includes a second fixing portion K2 (see FIG. 4B) disposed closer to the connector fitting direction X1 than the first fixing portion K1. As illustrated in FIG. 3, the plurality of terminals 4 include two pairs of power supply terminals 4A and a plurality of signal terminals 4B. The power supply terminal 4A and the signal terminal 4B have the same configuration. Each of the shunt terminals 5 is in contact with the corresponding pair of power supply terminals 4A (see FIG. 10A) and can shunt a current flowing through the power supply terminal 4A.

As illustrated in FIGS. 1A and 3, the pair of reinforcing tabs 6 each include a rectangular plate-like reinforcing tab main body 61 and a pair of leg portions 62 having an outward L shape and spaced apart in the connector fitting direction X1. The reinforcing tab main body 61 is press-fitted and fixed in the stationary housing 2. The pair of leg portions 62 extend downward from the reinforcing tab main body 61 and is fixed to a conductor portion (not illustrated) on the surface of the substrate.

First, the terminal 4 will be described.

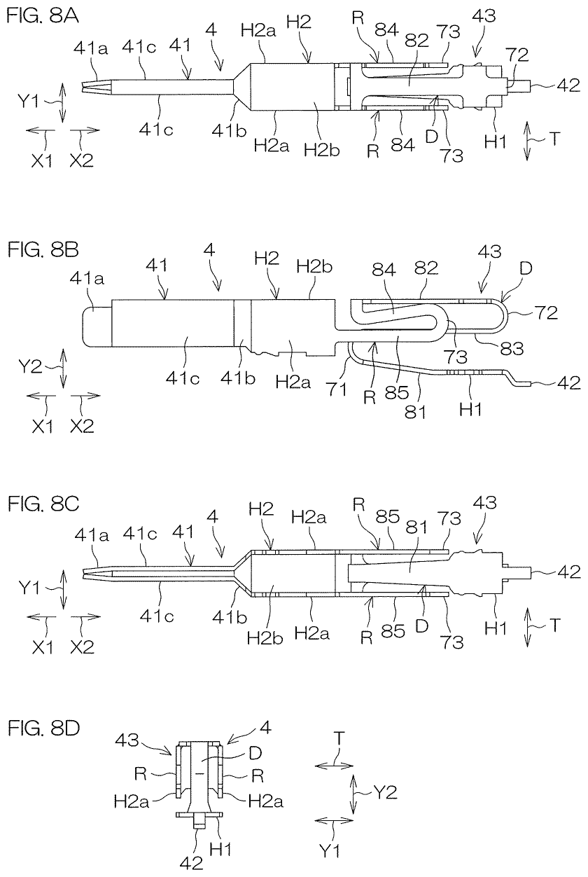

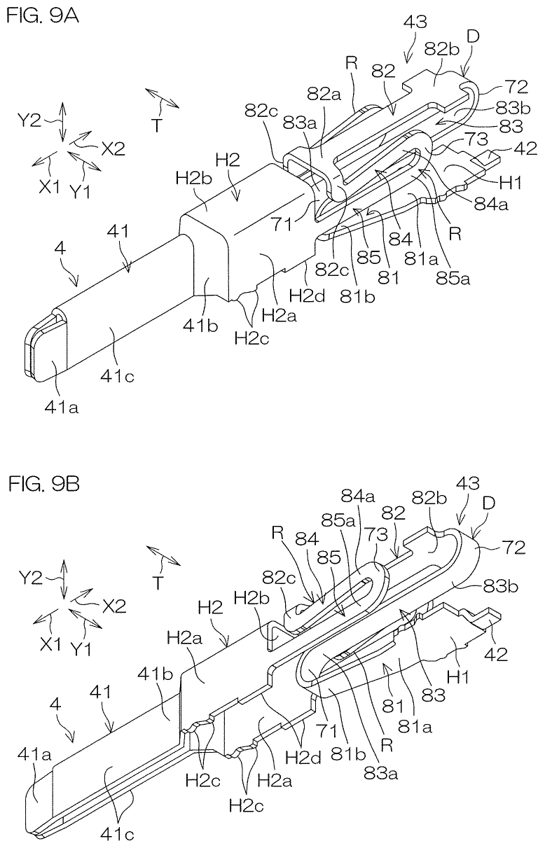

FIG. 8A is a plan view of the terminal 4, FIG. 8B is a side view of the terminal 4, FIG. 8C is a bottom view of the terminal 4, and FIG. 8D is a rear view of the terminal 4. FIGS. 9A and 9B are perspective views of the terminal 4 from different angles to each other.

As illustrated in FIGS. 9A and 9B, the terminal 4 includes a first fixed portion H1, a second fixed portion H2, a mating terminal fitting portion 41, a first lead 42, and an elastic portion 43. The terminal 4 is integrally formed of a single member. The first fixed portion H1 is press-fitted and fixed in the first fixing portion K1 (see FIG. 6) of the stationary housing 2. As illustrated in FIG. 4B, the second fixed portion H2 is press-fitted and fixed in the second fixing portion K2 of the movable housing 3. As illustrated in FIG. 8B, the first lead 42 extends from the first fixed portion H1 and is soldered to a conductor portion (not illustrated) on the surface of the substrate.

As illustrated in FIGS. 8A to 8C, the mating terminal fitting portion 41 extends from the first fixed portion H1 in the connector fitting direction X1. The mating terminal fitting portion 41 can be fitted to a mating terminal 93 (see FIG. 2A) which is, for example, a socket terminal accommodated and held in a mating housing 91 of the mating connector 90 (see FIG. 2B). The mating terminal fitting portion 41 has a plate shape of folding and stacking two plate portions. The mating terminal fitting portion 41 includes a distal end 41a, a proximal end 41b connected to the second fixed portion H2, and a pair of contact surface portions 41c extending in the connector fitting direction X1 and the second orthogonal direction Y2.

As illustrated in FIG. 8C, the distal end 41a of the mating terminal fitting portion 41 is formed to be tapered in the connector fitting direction X1 with respect to a thickness in the first orthogonal direction Y1. The proximal end 41b of the mating terminal fitting portion 41 is formed to expand toward the second fixed portion H2.

As illustrated in FIGS. 9A and 9B, the second fixed portion H2 includes a pair of opposing walls H2a facing each other in the first orthogonal direction Y1, a bridging wall H2b coupling the pair of opposing walls H2a, a press-fit protrusion H2c, and a positioning protrusion H2d. The second fixed portion H2 is formed in a groove shape.

Each of the opposing walls H2a extends in the connector fitting direction X1 and the second orthogonal direction Y2. The bridging wall H2b couples the upper edges of the pair of opposing walls H2a and extends in the connector fitting direction X1 and the first orthogonal direction Y1. The press-fit protrusion H2c and the positioning protrusion H2d are formed to protrude from the lower edge of each opposing wall H2a. The positioning protrusion H2d functions to position the press-fitting completion position when the second fixed portion H2 is press-fitted into the second fixing portion K2 of the movable housing 3 in the connector fitting direction X1.

The elastic portion 43 couples the first fixed portion H1 and the second fixed portion H2. The elastic portion 43 is elastically deformable along with the movement of the movable housing 3 with respect to three orthogonal directions including the connector fitting direction X1, the first orthogonal direction Y1, and the second orthogonal direction Y2.

As illustrated in FIG. 8B, the elastic portion 43 includes a meandering portion D that meanders in the connector fitting direction X1 and the opposite direction X2 to the connector fitting direction X1 and extends in the second orthogonal direction Y2 when viewed from the first orthogonal direction Y1 and a pair of coupling plate portions R (see FIGS. 9A and 9B) that couple the meandering portion D to the second fixed portion H2.

As illustrated in FIGS. 8B and 9B, when viewed from the first orthogonal direction Y1, the meandering portion D includes a first curved plate portion 71 having a folded-back shape that opens in the opposite direction X2, a second curved plate portion 72 having a folded-back shape that opens in the connector fitting direction X1, a first linear plate portion 81, a second linear plate portion 82, and a third linear plate portion 83 and forms a Z-shape when viewed from the first orthogonal direction Y1.

As illustrated in FIGS. 9A and 9B, the first linear plate portion 81 includes a first end 81a coupled to the first fixed portion H1 and a second end 81b coupled to the first curved plate portion 71. The second linear plate portion 82 includes a first end 82a coupled to the second fixed portion H2 via the pair of coupling plate portions R, a second end 82b coupled to the second curved plate portion 72, and a pair of bent edge portions 82c bent from the first end 82a. The pair of bent edge portions 82c faces each other in the first orthogonal direction Y1. The third linear plate portion 83 includes a first end 83a coupled to the second end 81b of the first linear plate portion 81 via the first curved plate portion 71 and a second end 83b coupled to the second end 82b of the second linear plate portion 82 via the second curved plate portion 72.

The pair of coupling plate portions R has a plate thickness direction T along the first orthogonal direction Y1. The pair of coupling plate portions R couple the pair of opposing walls H2a of the second fixed portion H2 to the pair of bent edge portions 82c facing each other in the first orthogonal direction Y1 at the first end 82a of the second linear plate portion 82.

Each coupling plate portion R includes a fourth linear plate portion 84, a fifth linear plate portion 85, and a third curved plate portion 73. The fourth linear plate portion 84 extends in the opposite direction X2 from the corresponding bent edge portion 82c of the first end 82a of the second linear plate portion 82. The fifth linear plate portion 85 extends in the opposite direction X2 from the corresponding opposing wall H2a of the second fixed portion H2. The third curved plate portion 73 is a curved plate portion having a folded-back shape that opens in the connector fitting direction X1 and is disposed between an extended end 84a of the fourth linear plate portion 84 and an extended end 85a of the fifth linear plate portion 85.

Next, the stationary housing 2 will be described.

As illustrated in FIGS. 5A and 5B, the stationary housing 2 includes a rectangular plate-shaped base wall 21, a rectangular parallelepiped main body block 22 disposed over a rear portion of the base wall 21, a pair of sidewalls 23, a first fixing portion K1 (see FIG. 6), and an accommodation portion S1 that accommodates the movable housing 3 (see FIG. 1A).

As illustrated in FIG. 5A, the accommodation portion S1 corresponds to a space above an upper surface 21a of the base wall 21 in the connector fitting direction X1 (front) of the main body block 22. As illustrated in FIG. 4B, the upper surface 21a of the base wall 21 functions as a receiving surface that receives a lower surface 31b of a main body block 31 of the movable housing 3 when located at the home position.

As illustrated in FIG. 5A, the main body block 22 includes a plurality of terminal accommodation holes 24 penetrating in the connector fitting direction X1 and arranged side by side in the first orthogonal direction Y1. As illustrated in FIG. 4B, a part of the corresponding terminal (most of the elastic portion 43) is accommodated in each terminal accommodation hole 24.

As illustrated in FIG. 6, each terminal accommodation hole 24 includes an inner upper surface 24a, an inner bottom surface 24b, a pair of inner side surfaces 24c, a pair of convex ribs 24d, and a pair of first fixing grooves 24e forming the first fixing portion K1 for fixing the first fixed portion H1 of the corresponding terminal 4. The pair of convex ribs 24d are disposed close to the inner bottom surface 24b, protrude from the pair of inner side surfaces 24c, and extend in the connector fitting direction X1. The corresponding first fixing groove 24e (the first fixing portion K1) is formed between each convex rib 24d and the inner bottom surface 24b.

As illustrated in FIGS. 5A and 5B, each sidewall 23 includes a front sidewall 23a, a rear sidewall 23b, and an intermediate sidewall 23c between the front sidewall 23a and the rear sidewall 23b. The intermediate sidewall 23c has a height such as to slightly protrude from the base wall 21. The rear surface of the front sidewall 23a and the front surface of the rear sidewall 23b include a pair of reinforcing tab fixing grooves 23d in which the reinforcing tab main body 61 is press-fitted and fixed.

Next, the movable housing 3 will be described.

As illustrated in FIGS. 7A and 7B, the movable housing 3 includes a rectangular parallelepiped main body block 31, a pair of restricted protrusions 32, and a guide arm 33.

The main body block 31 is accommodated in the accommodation portion S1 of the stationary housing 2. The main body block 31 includes an upper surface 31a, a lower surface 31b (see FIG. 4B), a front surface 31c, a rear surface 31d, a pair of side surfaces 31e, a plurality of terminal insertion holes 31f, and a plurality of second fixing portions K2 (see FIG. 4B).

As illustrated in FIGS. 7A and 7B, the plurality of terminal insertion holes 31f are arranged side by side in the first orthogonal direction Y1. Each terminal insertion hole 31f penetrates the front surface 31c and the rear surface 31d of the main body block 31 and extends in the connector fitting direction X1. As illustrated in FIG. 4B, the second fixing portion K2 is provided in the terminal insertion hole 31f. The second fixed portion H2 of the terminal 4 is press-fitted and fixed in the second fixing portion K2.

As illustrated in FIGS. 7A and 7B, the pair of restricted protrusions 32 protrude outward from the pair of side surfaces 31e of the main body block 31. As illustrated in FIG. 4A, each restricted protrusion 32 is inserted between the pair of leg portions 62 of the reinforcing tab 6 with respect to the connector fitting direction X1. In a state where the elastic portion 43 of the terminal 4 is at the home position, each of the restricted protrusions 32 is disposed at an intermediate position between the pair of leg portions 62. The moving range of each of the restricted protrusions 32 in the connector fitting direction X1 is restricted between the pair of leg portions 62. As a result, the moving range of the movable housing 3 in the connector fitting direction X1 is restricted.

Also, each restricted protrusion 32 is inserted between a lower edge 61a of the reinforcing tab main body 61 and an upper surface 23e of the intermediate sidewall 23c of the stationary housing 2 with respect to the second orthogonal direction Y2. In a state where the elastic portion 43 of the terminal 4 is at the home position, each of the restricted protrusions 32 abuts the upper surface 23e of the intermediate sidewall 23c. The moving range of each of the restricted protrusions 32 in the second orthogonal direction Y2 is restricted between the lower edge 61a of the reinforcing tab main body 61 and the upper surface 23e of the intermediate sidewall 23c of the stationary housing 2. As a result, the moving range of the movable housing 3 in the second orthogonal direction Y2 is restricted.

Also, in a state where the elastic portion 43 of the terminal 4 is at the home position, as illustrated in FIG. 1A, each side surface 31e of the main body block 31 of the movable housing 3 is separated from the corresponding reinforcing tab main body 61 in the first orthogonal direction Y1 by a predetermined interval. The moving range of the movable housing 3 in the first orthogonal direction Y1 is restricted by the pair of reinforcing tab main bodies 61.

As illustrated in FIG. 7A, the guide arm 33 protrudes from the front surface 31c of the main body block 31 in the connector fitting direction X1. The guide arm 33 forms a rectangular cross-sectional shape including an upper surface, a lower surface, and a pair of side surfaces and extends in the connector fitting direction X1.

As illustrated in FIG. 2A, the guide arm 33 is formed in a tapered shape as viewed in the second orthogonal direction Y2. Specifically, the pair of side surfaces of the distal end portion of the guide arm 33 include a pair of guide surfaces 33a inclined in directions opposite to each other with respect to the connector fitting direction X1. Also, as illustrated in FIG. 4A, the guide arm 33 is formed in a tapered shape as viewed in the first orthogonal direction Y1. Specifically, the lower surface of the distal end portion of the guide arm 33 includes a guide surface 33b inclined upward with respect to the connector fitting direction X1.

As illustrated in FIGS. 2A and 2B, prior to the operation in which the mating terminal fitting portion 41 is fitted to the mating terminal (not illustrated) of the mating connector 90, the guide arm 33 functions to guide the fitting of the terminal 4 and the mating terminal 93 (see FIG. 2A) (that is, the fitting of the floating connector 1 and the mating connector 90) by being guided and inserted into a guide hole 92 having a cross-sectional groove shape of the mating housing 91 of the mating connector 90. Also, the guide arm 33 functions to transmit the movement of the mating connector 90 in a fitted state to the movable housing 3.

Next, the shunt terminal 5 will be described.

FIGS. 10A and 10B are perspective views of the pair of power supply terminals 4A to which the shunt terminal 5 is attached, from different angles to each other. As illustrated in FIGS. 10A and 10B, the shunt terminal 5 is attached to the pair of power supply terminals 4A and functions to shunt a current flowing through the power supply terminal 4A. Specifically, the shunt terminal 5 includes a groove-shaped shunt terminal main body 51 press-fitted and fixed in the terminal accommodation hole 24 (see FIG. 4B) of the stationary housing 2, a pair of second leads 52, and a pair of elastic piece portions 53 each including a contact portion 54.

As illustrated in FIGS. 10A and 10B, the shunt terminal main body 51 includes a pair of heat dissipation side plates 51a as a pair of heat dissipation plates facing each other in the first orthogonal direction Y1 and a coupling upper plate 51b as a coupling plate coupling upper edge rear portions of the pair of heat dissipation side plates 51a. Each of the second leads 52 protrudes downward from the rear lower edge of the corresponding heat dissipation side plate 51a and is soldered to a conductor portion (not illustrated) on the surface of the substrate. Press-fit protrusions 51c are formed on the lower edges of the pair of heat dissipation side plates 51a.

The pair of elastic piece portions 53 extend slightly obliquely downward with respect to the connector fitting direction X1 from the coupling upper plate 51b of the shunt terminal main body 51. Each of the contact portions 54 is, for example, a dimple protrusion protruding downward from the corresponding elastic piece portion 53 and is elastically brought into press contact with the rear portion of the bridging wall H2b of the second fixed portion H2 of the corresponding power supply terminal 4A (see FIG. 4B).

The pair of heat dissipation side plates 51a are disposed on both sides sandwiching the pair of power supply terminals 4A. The heat dissipation side plate 51a extends between the contact portion 54 and the second lead 52, functions to dissipate heat generated by the passage of a current, and suppresses a temperature rise of the power supply terminal 4A and the shunt terminal 5.

Next, an operation in which the elastic portion 43 of the terminal 4 elastically absorbs the movement of the movable housing 3 will be described. Along with the movement of the movable housing 3 with respect to the stationary housing 2, the second fixed portion H2 moves with respect to the first fixed portion H1 of the terminal 4, and the movement is absorbed by the elastic deformation of the elastic portion 43.

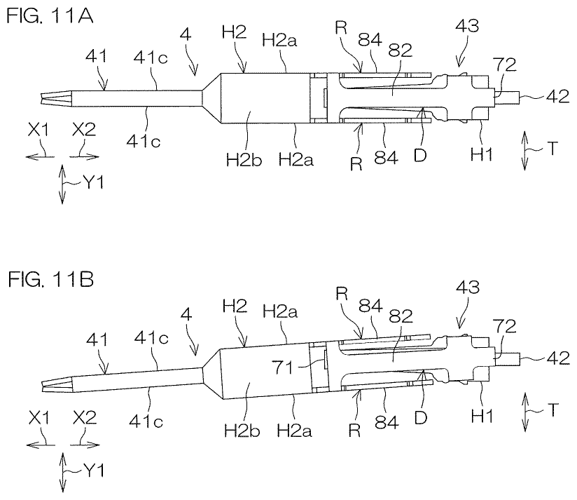

First, the operation of the terminal 4 when absorbing the movement in the first orthogonal direction Y1 by the elastic portion 43 will be described. FIG. 11A is a plan view of the terminal 4 when the movable housing 3 (not illustrated in FIG. 11A) is not subjected to an external force from the mating connector, that is, when the movable housing 3 is at the home position. FIG. 11B is a plan view of the terminal 4 when absorbing the movement in the first orthogonal direction Y1.

As illustrated in FIG. 11B, when the second fixed portion H2 (movable housing 3) moves in the first orthogonal direction Y1, the front half portion (half portion on the connector fitting direction X1 side) of the terminal 4 moves in the first orthogonal direction Y1, while the first fixed portion H1 of the terminal 4 does not move. Therefore, as illustrated in FIG. 11B, when viewed along the second orthogonal direction Y2 (direction orthogonal to a paper plane), the contact surface portion 41c of the mating terminal fitting portion 41 of the terminal 4 and the opposing wall H2a of the second fixed portion H2 are inclined with respect to the connector fitting direction X1, and accordingly, the elastic portion 43 is elastically deformed.

Specifically, in the meandering portion D, each of the first curved plate portion 71 and the second curved plate portion 72 that open in opposite directions with respect to the connector fitting direction X1 is elastically and torsionally deformed. Also, each of the pair of coupling plate portions R is elastically and torsionally deformed. The torsional deformation of the coupling plate portion R is such that, when viewed along the second orthogonal direction Y2, the fourth linear plate portion 84 and the fifth linear plate portion 85 are twisted in directions opposite to each other with respect to the third curved plate portion 73 in the first orthogonal direction Y1, thereby twisting the third curved plate portion 73. The movement of the movable housing 3 in the first orthogonal direction Y1 can be satisfactorily absorbed by using the elastic torsional deformation of the first curved plate portion 71 and the second curved plate portion 72 and the elastic torsional deformation of the pair of coupling plate portions R.

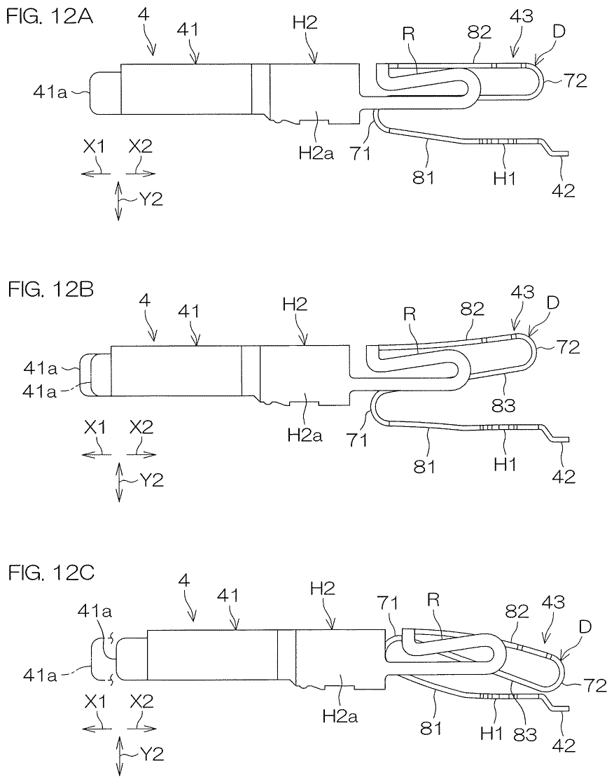

Next, the operation of the terminal 4 when absorbing the movement of the movable housing 3 in the connector fitting direction X1 (the direction in which the terminal 4 is pulled) and the movement of the movable housing 3 in the opposite direction X2 (the direction in which the terminal 4 is pushed) will be described. FIG. 12A is a side view of the terminal 4 at the home position. FIG. 12B is a side view of the terminal 4 when pulled in the connector fitting direction X1. FIG. 12C is a side view of the terminal 4 when pushed in the opposite direction X2.

As illustrated in FIG. 12B, when the terminal 4 is pulled in the connector fitting direction X1 by the movement of the movable housing 3 (not illustrated in FIG. 12B), the meandering portion D between the first fixed portion H1 and the second fixed portion H2 is elastically deformed such as to be stretched in the connector fitting direction X1. An aspect of the elastic deformation is as follows. That is, of the first curved plate portion 71 and the second curved plate portion 72, the first curved plate portion 71 is mainly curved. The second curved plate portion 72 rises along with the opening of the curve of the first curved plate portion 71, and the rear half portion of the second linear plate portion 82 and the third linear plate portion 83 are inclined with respect to the connector fitting direction X1 such as to rise toward the opposite direction X2. This elastic deformation can absorb the movement of the movable housing 3 in the connector fitting direction X1.

As illustrated in FIG. 12C, when the terminal 4 is pushed in the opposite direction X2 by the movement of the movable housing 3 (not illustrated in FIG. 12C), the meandering portion D between the first fixed portion H1 and the second fixed portion H2 is elastically deformed such as to be contracted in the opposite direction X2. An aspect of the elastic deformation is as follows. That is, the first curved plate portion 71 rises, and the second curved plate portion 72 lowers. Also, the first linear plate portion 81, the second linear plate portion 82, and the third linear plate portion 83 are inclined with respect to the connector fitting direction X1 such as to become lower in the opposite direction X2. This elastic deformation can absorb the movement of the movable housing 3 in the opposite direction X2.

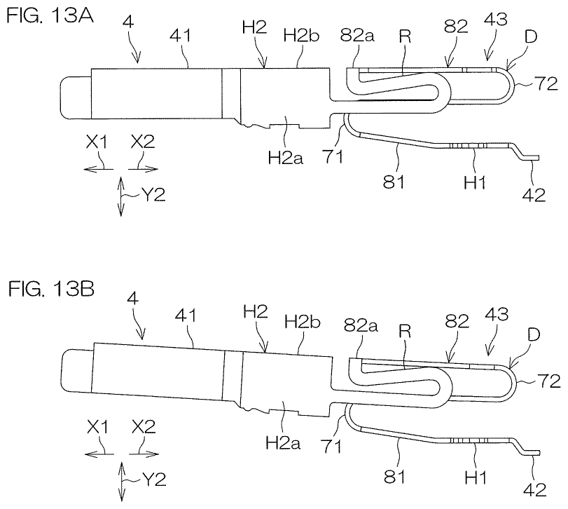

Next, the operation of the terminal 4 when absorbing the movement of the movable housing 3 in the second orthogonal direction Y2 will be described. FIG. 13A is a side view of the terminal 4 when the terminal 4 is at the home position and FIG. 13B is a side view of the terminal when the movement in the second orthogonal direction Y2 is absorbed.

As illustrated in FIG. 13B, when the movable housing 3 (not illustrated in FIG. 13B) moves in the second orthogonal direction Y2, the front half portion (half portion on the connector fitting direction X1 side) of the terminal 4 moves in the first orthogonal direction Y1, while the first fixed portion H1 of the terminal 4 does not move. Therefore, as illustrated in FIG. 13B, when viewed along the first orthogonal direction Y1 (direction orthogonal to a paper plane), the bridging wall H2b of the second fixed portion H2 of the terminal 4 is inclined with respect to the connector fitting direction X1, and accordingly, in the elastic portion 43, the first end 82a of the second linear plate portion 82 rises (or lowers), so that the meandering portion D is elastically deformed. This elastic deformation can absorb the movement of the movable housing 3 in the second orthogonal direction Y2.

According to the present embodiment, the terminal 4 integrally formed of a single member can elastically absorb the movement of the movable housing 3 with respect to the three orthogonal directions by the elastic portion 43. Therefore, the number of parts can be reduced, and the number of assembling steps at the time of manufacturing can be reduced.

Also, when viewed in the first orthogonal direction Y1, the elastic portion 43 includes the meandering portion D that meanders in the connector fitting direction X1 and the opposite direction X2 and extends in the second orthogonal direction Y2, and the meandering portion D includes the first curved plate portion 71 and the second curved plate portion 72 that are folded back and open in opposite directions to each other with respect to the connector fitting direction X1. According to this configuration, when the movable housing 3 moves in the first orthogonal direction Y1, in the meandering portion D, the movement of the movable housing 3 in the first orthogonal direction Y1 can be satisfactorily absorbed by using the elastic torsional deformation of the first curved plate portion 71 and the second curved plate portion 72.

Also, the meandering portion D forms a Z-shape including the first linear plate portion 81, the second linear plate portion 82, the third linear plate portion 83, the first curved plate portion 71 between the first linear plate portion 81 and the third linear plate portion 83, and the second curved plate portion 72 between the second linear plate portion 82 and the third linear plate portion 83 as viewed in the first orthogonal direction Y1. According to this configuration, it is possible to satisfactorily absorb the movement of the movable housing 3 in the connector fitting direction X1 and in the opposite direction X2 by using the elastic deformation of the meandering portion D having the Z-shape.

Also, the second fixed portion H2 includes the pair of opposing walls H2a facing each other in the first orthogonal direction Y1 and the bridging wall H2b extending in the connector fitting direction X1 and the first orthogonal direction Y1 and coupling the pair of opposing walls H2a. The elastic portion 43 includes the pair of coupling plate portions R each of which couples the pair of opposing walls H2a of the second fixed portion H2 to the pair of bent edge portions 82c facing each other in the first orthogonal direction Y1 at the first end 82a of the second linear plate portion 82. The coupling plate portion R has the plate thickness direction T along the first orthogonal direction Y1 and is elastically and torsionally deformable as the movable housing 3 moves in the first orthogonal direction Y1.

According to this configuration, when the movable housing 3 moves in the first orthogonal direction Y1, by using the elastic torsional deformation of the pair of coupling plate portions R in addition to the elastic torsional deformation of the first curved plate portion 71 and the second curved plate portion 72, the movement of the movable housing 3 in the first orthogonal direction Y1 can be more satisfactorily absorbed.

Also, each of the pair of coupling plate portions R includes the fourth linear plate portion 84 extending in the opposite direction X2 from the corresponding bent edge portion 82c of the first end 82a of the second linear plate portion 82, the fifth linear plate portion 85 extending in the opposite direction X2 from the corresponding opposing wall H2a of the second fixed portion H2, and the third curved plate portion 73 having a folded-back shape between the extended end 84a of the fourth linear plate portion 84 and the extended end 85a of the fifth linear plate portion 85. According to this configuration, by using the elastic torsional deformation of the third curved plate portion 73 between the fourth linear plate portion 84 and the fifth linear plate portion 85 in addition to the elastic torsional deformation of the first curved plate portion 71 and the second curved plate portion 72 of the meandering portion D, the movement of the movable housing 3 in the first orthogonal direction Y1 can be satisfactorily absorbed.

Also, a current flowing through the power supply terminal 4A can be shunted by the shunt terminal 5 including the contact portion 54 in contact with the power supply terminal 4A and the second lead 52 connectable to the substrate. Also, since the shunt terminal 5 includes the heat dissipation side plate 51a, the temperature rise of the power supply terminal 4A and the shunt terminal 5 can be suppressed.

Also, in a case where the mating connector 90 is provided in a battery or a battery pack, it is possible to obtain a battery connector which is a floating connector capable of reducing the number of parts and reducing the number of assembling steps at the time of manufacturing.

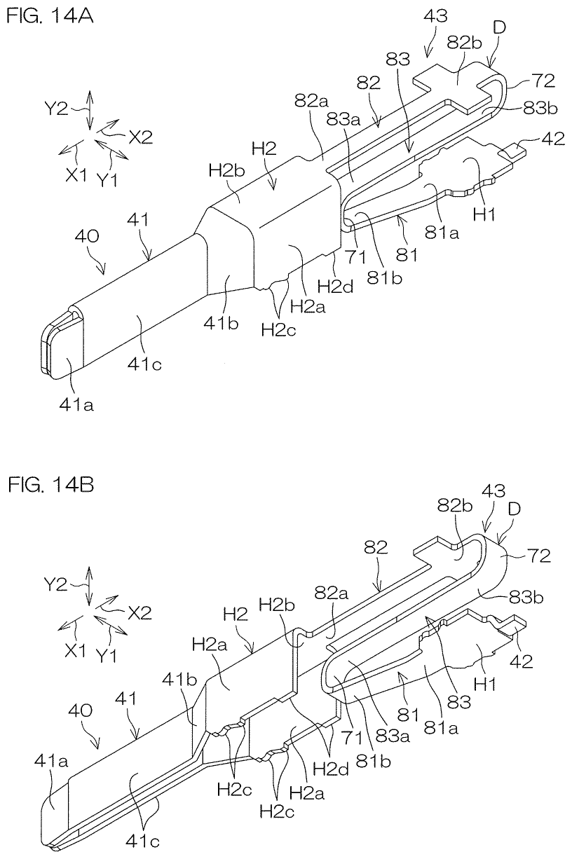

Next, a terminal 40 of the floating connector according to a modification will be described. FIGS. 14A and 14B are perspective views of the terminal 40 according to the modification from different angles to each other. The terminal 40 according to the modification of FIGS. 14A and 14B is mainly different from the terminal 4 of FIGS. 9A and 9B in that the coupling plate portion R of the terminal 4 of FIGS. 9A and 9B is not provided, and the first end 82a of the second linear plate portion 82 is directly coupled to the rear edge of the bridging wall H2b of the second fixed portion H2. In the configuration of the terminal 40, a configuration common to the terminal 4 of FIGS. 9A and 9B is denoted by a common reference symbol.

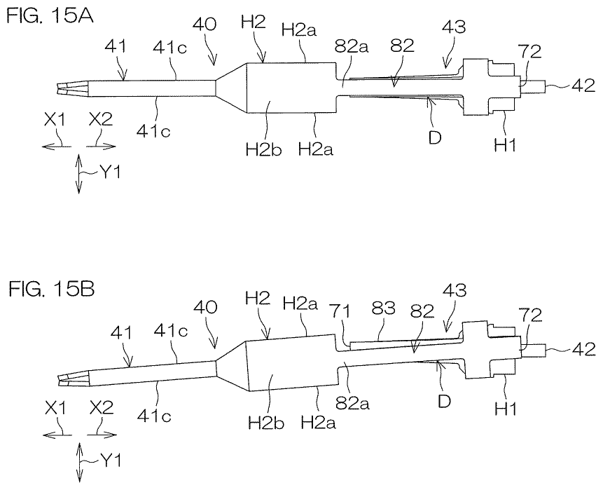

FIG. 15A is a plan view of the terminal 40 according to the modification when the terminal 40 is at the home position, and FIG. 15B is a plan view of the terminal 40 according to the modification when the displacement in the first orthogonal direction Y1 is absorbed. As illustrated in FIG. 15B, the movement of the movable housing 3 in the first orthogonal direction Y1 can be satisfactorily absorbed by using the elastic torsional deformation of the first curved plate portion 71 and the second curved plate portion 72.

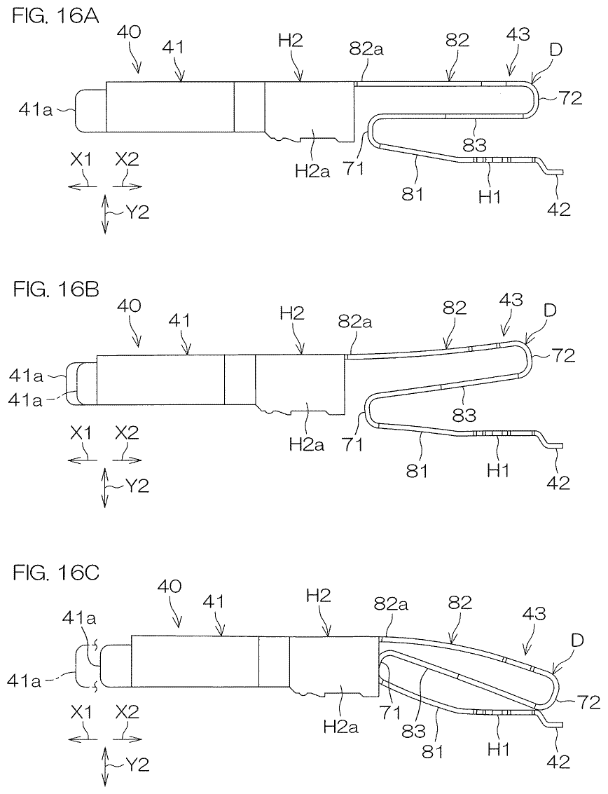

FIG. 16A is a side view of the terminal 40 according to the modification when the terminal 40 is at the home position, FIG. 16B is a side view of the terminal 40 according to the modification when pulled in the connector fitting direction X1, and FIG. 16C is a side view of the terminal 40 according to the modification when pushed in the opposite direction X2 to the connector fitting direction X1.

As illustrated in FIG. 16B, the second curved plate portion 72 rises along with the opening of the curve of the first curved plate portion 71 in the connector fitting direction X1, and the rear half portion of the second linear plate portion 82 and the third linear plate portion 83 are inclined with respect to the connector fitting direction X1 such as to rise toward the opposite direction X2. This elastic deformation can absorb the movement of the movable housing 3 in the connector fitting direction X1.

As illustrated in FIG. 16C, the first curved plate portion 71 rises, and the second curved plate portion 72 lowers. Also, the first linear plate portion 81, the second linear plate portion 82, and the third linear plate portion 83 are inclined with respect to the connector fitting direction X1 such as to become lower in the opposite direction X2. This elastic deformation can absorb the movement of the movable housing 3 in the opposite direction X2.

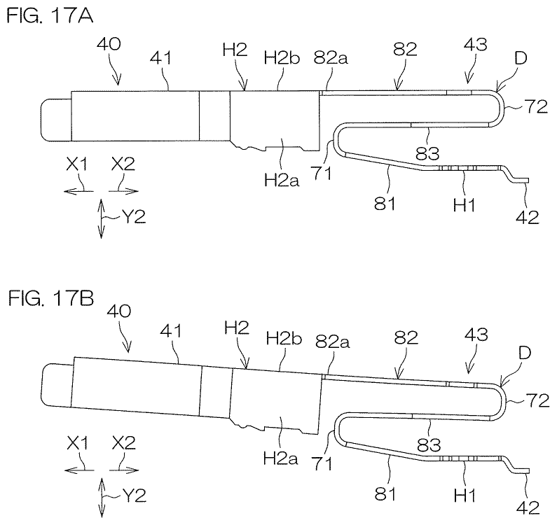

FIG. 17A is a side view of the terminal 40 according to the modification when the terminal 40 is at the home position, and FIG. 17B is a side view of the terminal 40 according to the modification when the displacement in the second orthogonal direction Y2 is absorbed. As illustrated in FIG. 17B, when viewed along the first orthogonal direction Y1 (direction orthogonal to a paper plane), the bridging wall H2b of the second fixed portion H2 of the terminal 40 is inclined with respect to the connector fitting direction X1, and accordingly, in the elastic portion 43, the first end 82a of the second linear plate portion 82 rises (or lowers), so that the meandering portion D is elastically deformed. This elastic deformation can absorb the movement of the movable housing 3 in the second orthogonal direction Y2.

According to the modification, the terminal 40 integrally formed of a single member can elastically absorb the movement of the movable housing 3 with respect to the three orthogonal directions by the elastic portion 43. Therefore, the number of parts can be reduced, and the number of assembling steps at the time of manufacturing can be reduced. Also, the structure of the elastic portion 43 can be simplified by directly coupling the first end 82a of the second linear plate portion 82 of the meandering portion D to the bridging wall H2b of the second fixed portion H2.

The present invention is not limited to the above preferred embodiment, and for example, although not illustrated, the meandering portion D may be formed in an S-shape when viewed from the first orthogonal direction Y1. In addition, the present invention can be variously modified within the scope of the claims.

Although the present invention has been described in detail with reference to specific aspects, those skilled in the art who understand the above content will readily conceive of modifications, changes, and equivalents thereof. Therefore, the present invention should be regarded as being within the scope of the claims and their equivalents.

### REFERENCE SIGNS LIST

1: FLOATING CONNECTOR
2: stationary housing
3: movable housing
4; 40: terminal
4A: power supply terminal
4B: signal terminal
5: shunt terminal
33: guide arm
41: mating terminal fitting portion
42: first lead
43: elastic portion
51a: heat dissipation side plate (heat dissipation plate)
52: second lead
54: elastic portion
71: first curved plate portion
72: second curved plate portion
73: third curved plate portion
81: first linear plate portion
81a: first end
81b: second end
82: second linear plate portion
82a: first end
82b: second end
83: third linear plate portion
83a: first end
83b: second end
84: fourth linear plate portion
84a: extended end
85: fifth linear plate portion
85a: extended end
90: mating connector
91: mating housing
92: guide hole
93: mating terminal
D: meandering portion
H1: first fixed portion
H2: second fixed portion
H2a: opposing wall
H2b: bridging wall
K1: first fixing portion
K2: second fixing portion
R: coupling plate portion
S1: accommodating portion
T: plate thickness direction
X1: connector fitting direction
X2: opposite direction
Y1: first orthogonal direction
Y2: second orthogonal direction

What is claimed is:

1. A floating connector comprising:
a stationary housing including a first fixing portion and an accommodation portion;
a movable housing including a second fixing portion disposed closer to a connector fitting direction than the first fixing portion and being accommodated in the accommodation portion in a loosely fitted state; and
a terminal integrally formed of a single member,
wherein the terminal includes a first fixed portion fixed to the first fixing portion, a second fixed portion fixed to the second fixing portion, a mating terminal fitting portion protruding from the second fixed portion in the connector fitting direction and configured to be fitted to a mating terminal, and an elastic portion coupling the first fixed portion and the second fixed portion to each other, and
the elastic portion is configured to be elastically deformable along with movement of the movable housing with respect to three orthogonal directions including the connector fitting direction, as well as a first orthogonal direction and a second orthogonal direction which are orthogonal to the connector fitting direction.

2. The floating connector according to claim 1, wherein the elastic portion includes a meandering portion that meanders in the connector fitting direction and an opposite direction to the connector fitting direction and extends in the second orthogonal direction when viewed from the first orthogonal direction, and
the meandering portion includes a first curved plate portion having a folded-back shape opening in the opposite direction and a second curved plate portion having a folded-back shape opening in the connector fitting direction.

3. The floating connector according to claim 2, wherein the meandering portion includes a first linear plate portion, a second linear plate portion, and a third linear plate portion and forms a Z-shape when viewed from the first orthogonal direction.

4. The floating connector according to claim 3, wherein the first linear plate portion includes a first end coupled to the first fixed portion and a second end,
the second linear plate portion includes a first end coupled to the second fixed portion and a second end, and
the third linear plate portion includes a first end coupled to the second end of the first linear plate portion via the first curved plate portion and a second end coupled to the second end of the second linear plate portion via the second curved plate portion.

5. The floating connector according to claim 4, wherein the second fixed portion includes a pair of opposing walls facing each other in the first orthogonal direction and a bridging wall extending in the connector fitting direction and the first orthogonal direction and coupling the pair of opposing walls to each other, and
the first end of the second linear plate portion is coupled to the bridging wall.

6. The floating connector according to claim 4, wherein the second fixed portion includes a pair of opposing walls facing each other in the first orthogonal direction and a bridging wall extending in the connector fitting direction and the first orthogonal direction and coupling the pair of opposing walls to each other,
the second linear plate portion includes a pair of bent edge portions that are bent from the first end of the second linear plate portion and face each other in the first orthogonal direction,
the elastic portion includes a pair of coupling plate portions that couple the pair of opposing walls of the second fixed portion to the pair of bent edge portions of the second linear plate portion, and
each of the pair of coupling plate portions has a plate thickness direction along the first orthogonal direction and is configured to be elastically and torsionally deformable along with movement of the movable housing in the first orthogonal direction.

7. The floating connector according to claim 6, wherein each of the pair of coupling plate portions includes a fourth linear plate portion extending in the opposite direction from the corresponding edge portion of the first end of the second linear plate portion, a fifth linear plate portion extending in the opposite direction from the corresponding opposing wall of the second fixed portion, and a third curved plate portion having a folded-back shape between an extended end of the fourth linear plate portion and an extended end of the fifth linear plate portion.

8. The floating connector according to claim 1, further comprising a shunt terminal,
wherein the terminal includes a power supply terminal including a first lead extending from the first fixed portion and configured to be connectable to a substrate, and
the shunt terminal includes a contact portion in contact with the power supply terminal, a second lead configured to be connectable to the substrate, and a heat dissipation plate extending between the contact portion and the second lead and is configured to shunt a current flowing through the power supply terminal.

9. The floating connector according to claim 1, wherein the mating terminal connection portion is configured to be connectable to a mating terminal of a mating connector provided in a battery or a battery pack.
